(19) United States
(12) Patent Application Publication
(10) Pub. No.: US 2025/0371240 A1
(43) Pub. Date: Dec. 4, 2025

(54) SEMICONDUCTOR DESIGN SYSTEM AND METHOD OF DESIGNING A SEMICONDUCTOR DEVICE USING THE SAME

(71) Applicant: SK hynix Inc., Icheon-si Gyeonggi-do (KR)

(72) Inventors: Kyung Hoon KIM, Icheon-si Gyeonggi-do (KR); Unoh KWON, Icheon-si Gyeonggi-do (KR); Myung Hee NA, Icheon-si Gyeonggi-do (KR); Myeong Jae PARK, Icheon-si Gyeonggi-do (KR); Ji Eun JANG, Icheon-si Gyeonggi-do (KR)

(73) Assignee: SK hynix Inc., Icheon-si Gyeonggi-do (KR)

(21) Appl. No.: 18/917,074

(22) Filed: Oct. 16, 2024

(30) Foreign Application Priority Data
May 28, 2024 (KR) 10-2024-0069294

(51) Int. Cl. G06F 30/392; G06F 111/20

(52) U.S. Cl. CPC G06F 30/392; G06F 2111/20

(57) ABSTRACT

A semiconductor design system and a method for designing a semiconductor device using the system include a design tool configured to: determine a target circuit block to designed; select a standard cell configured to perform a function of the target circuit block; determine a detailed configuration of the target circuit block according to a power characteristic and an input/output characteristic of the target circuit block; based on circuit block information including the detailed configuration of the target circuit block, a device type to which the target circuit block is applied, and an integration location for the target circuit block, select an alt-standard cell among a plurality of alt-standard cells associated with the selected standard cell, for which the alt-standard cell has circuit block information that most closely matches the circuit block information for the target circuit block; and lay out the target circuit block by loading the selected alt-standard cell.

### CROSS-REFERENCES TO RELATED APPLICATION

The present application claims priority under 35 U.S.C. § 119 (a) to Korean patent application number 10-2024-0069294, filed on May 28, 2024, in the Korean Intellectual Property Office, which application is incorporated herein by reference in its entirety.

### BACKGROUND

### 1. Technical Field

Various embodiments of the present disclosure relate to semiconductor design, including but not limited to a semiconductor design system and a method of designing a semiconductor device using the semiconductor design system.

### 2. Related Art

A semiconductor device includes a plurality of circuit blocks that perform different functions.

Each circuit block includes, for example, a combination of at least one NMOS transistor, at least one PMOS transistor, and at least one passive element.

Before the circuit blocks are integrated on a semiconductor substrate, a layout of the circuit blocks is determined by a simulation program. Subsequently, when masks that manufacture the circuit blocks are fabricated, the layout of the circuit blocks is loaded into a mask design system. The layout of the circuit block may be referred to as a standard cell. Various standard cells for fabricating the circuit block are stored in a standard library.

### SUMMARY

According to an embodiment, a semiconductor design system may include: a design information medium configured to provide first design information and second design information, the first design information including information about a plurality of circuit blocks configured to be integrated into a semiconductor device and at least one function of the plurality of circuit blocks, and the second design information including an integration location of the plurality of circuit blocks and an input/output characteristic of the plurality of circuit blocks; a cell library configured to a store layout pattern of each of the plurality of circuit blocks as a different one of a plurality of standard cells; and a design tool operably coupled to the design information medium and the cell library, configured to select a standard cell, among the plurality of standard cells, including a layout pattern of a target circuit block based on the first design information and the second design information, and configured to load the layout pattern of the selected standard cell; wherein each of the plurality of standard cells of the cell library is categorized based on the first design information; and wherein each of the standard cells includes a plurality of alt-standard cells, each of the plurality of alt-standard cells having a different layout pattern based on the second design information.

According to an embodiment, method of designing a semiconductor device may include: determining, by a design tool, a target circuit block to designed; identifying, by the design tool, a function of the target block; selecting, by the design tool, a standard cell configured to perform the function of the target circuit block; determining, by the design tool, a detailed configuration of the target circuit block according to a power characteristic and an input/output characteristic of the target circuit block; based on circuit block information including the detailed configuration of the target circuit block, a device type to which the target circuit block is applied, and an integration location for the target circuit block, selecting, by the design tool, an alt-standard cell among a plurality of alt-standard cells associated with the selected standard cell, for which the alt-standard cell has circuit block information that most closely matches the circuit block information for the target circuit block; and laying out, by the design tool, the target circuit block by loading the selected alt-standard cell.

According to an embodiment, a semiconductor design system may include a processor and memory including stored instructions that, when executed by the processor, perform functions of a design tool including: generating design information and a control command that selects detailed configurations based on the design information for a target circuit block that performs a function; in response to receiving the command, selecting a standard cell, from a plurality of standard cells, that performs the function; selecting an alt-standard cell included in the standard cell, which alt-standard cell has detailed design information that most closely matches design information for the target circuit block; and laying out the target circuit block by loading the selected alt-standard cell.

### BRIEF DESCRIPTION OF THE DRAWINGS

FIG. 1 is a block diagram illustrating a semiconductor design system in accordance with an embodiment;

FIG. 2 is a block diagram illustrating a cell library in accordance with an embodiment;

FIG. 3 is a flowchart illustrating a method of designing a semiconductor device utilizing a semiconductor design system in accordance with an embodiment;

FIG. 4 is a schematic illustrating an example of a target circuit block in accordance with an embodiment;

FIG. 5 is a circuit diagram illustrating an example of a detailed configuration of a latch circuit block in accordance with an embodiment;

FIG. 6 illustrates a layout of an alt-standard cell in accordance with an embodiment; and

FIG. 7 is a view illustrating a layout of an alt-standard cell in accordance with an embodiment.

### DETAILED DESCRIPTION

Embodiments of the present disclosure are described detail with reference to the accompanying drawings. Specific structural or functional descriptions of embodiments are provided as examples to describe concepts that are disclosed in the present application. Examples or embodiments in accordance with the concepts may be carried out in various forms, and the scope of the present disclosure is not limited to the examples or embodiments described in this specification.

The cross-hatching throughout the figures illustrates corresponding or similar areas between the figures rather than indicating the materials associated with the areas.

As functions and forms of semiconductor devices are diversifying, different characteristics may be specified for each semiconductor device for circuit blocks performing the same function. The present disclosure describes a semiconductor design system for circuit blocks suitable to accommodate characteristics applicable to a semiconductor device.

An embodiment describes a semiconductor design system. The semiconductor design system includes a design information medium, a cell library, and a design tool.

In an embodiment, the design information medium may provide design information including a type of a semiconductor device, types of a plurality of circuit blocks in the semiconductor device, and integration locations of the plurality of the circuit blocks. The cell library may store layout patterns of the plurality of the circuit blocks as standard cells. Based on first design information and second design information, the design tool may select a target circuit block to be formed and a standard cell including the layout patterns of the target circuit block. The design tool may load the selected standard cell into a layout of the target circuit block. Each of the standard cells in the cell library may be categorized based on the first design information. Each of the standard cells may include a plurality of alt-standard cells having different layout patterns based on the second design information.

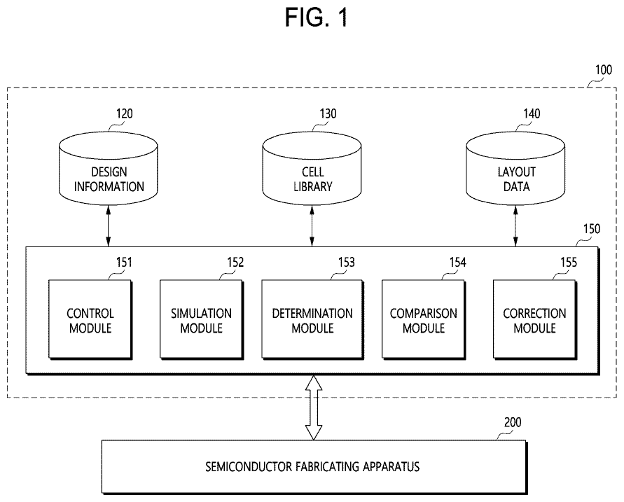

FIG. 1 is a block diagram illustrating a semiconductor design system in accordance with an embodiment.

Referring to FIG. 1, a semiconductor design system 100 includes a design information medium 120, a cell library 130, a layout data medium 140, and a design tool 150. The semiconductor design system 100 interfaces with an apparatus 200 that fabricates semiconductor device. The semiconductor design system 100 is implemented, for example, with a processor, or similar computing device, and a memory that includes stored instructions that when executed by the processor perform the processes and methods of the semiconductor design system 100 as described with reference to FIG. 1 through FIG. 7. The processor may be a microprocessor, central processing unit, computer, computing device, computing system, or other circuitry, device, machine, or system capable of executing the instructions stored in the memory. The memory may be a non-volatile memory device such as a cache, disk, RAM, ROM, flash drive, memory stick, and so forth capable of storing and downloading instructions that when executed by the processor perform processes and methods as described with reference to FIG. 1 through FIG. 7. The memory may also store data utilized during execution of the instructions. The memory may be built-in memory on the processor. Alternatively, the semiconductor design system 100 may be implemented with logic gates.

The design information medium 120 stores design information. For example, the design information includes first design information and second design information. The first design information includes information about a plurality of circuit blocks that form a semiconductor device. The first design information includes, for example, various functions of each of the plurality of circuit blocks. The second design information includes, for example, a product in which the semiconductor device is to be utilized, a location where the circuit blocks are integrated on a substrate or other position within the semiconductor device, and input/output characteristics of the plurality of the circuit blocks. At least one of the first design information and second design information may include a netlist including design constraint information. The netlist may include a hardware description language (HDL) such as Verilog.

The cell library 130 includes a plurality of standard cells. The cell library 130 includes local random variation information (LRVI) of the plurality of standard cells and global variation information (GVI) of the plurality of standard cells. The cell library 130 includes delay information for the plurality of standard cells, functional descriptions of the plurality of standard cells, power information for the plurality of standard cells, and noise information for the plurality of standard cells.

In an embodiment, each of the plurality of standard cells is one layout of a layout collection of circuit blocks configured to perform specific functions. Each standard cell includes layouts for a plurality of electric components and interconnections connected between the plurality of electric components. For example, a layout structure of an inverter including NMOS transistors and PMOS transistors is stored as a standard cell. When a circuit block of the semiconductor device including the inverter as the electric component is designed, the standard cell for the inverter is loaded into a circuit design system to reduce the time and energy of individually designing the NMOS transistor, the PMOS transistor, and the interconnections connected between the NMOS transistors and the PMOS transistors.

For example, the plurality of standard cells stored in the cell library 130 are categorized based on the first design information. Each of the standard cells of the cell library 130 includes a plurality of alt-standard cells categorized based on the second design information different from the first design information. A detailed structure of the cell library 130 is described in more detail.

The layout data medium 140 stores the first design information and the second design information. The first design information and the second design information include various layout data of the circuit blocks. For example, the layout data is determined by the alt-standard cell selected depending on function(s) and purpose(s) of the semiconductor device into which the circuit block is integrated, and place and route of the alt-standard cell.

The layout data medium 140 stores reference electrical characteristics and reference sizes for the circuit blocks in the semiconductor device as the layout data. For example, the electrical characteristics include input/output voltages and input/output currents, wiring resistance, and voltage/current losses of the target circuit blocks. The reference size includes areas of transistors constituting the circuit blocks, gate widths of the transistors, lengths and widths of the wirings, and contact areas. The layout data medium 140 stores corrected or updated reference electrical characteristics and reference sizes as provided to the layout data medium 140.

A method of fabricating a semiconductor device includes determining a plurality of circuit blocks that form the semiconductor device, designing layouts of a plurality of circuit blocks, forming a plurality of masks according to the layouts of the circuit blocks, and integrating the circuit blocks into appropriate locations on a semiconductor substrate using the plurality masks.

For example, the standard cells are obtained by designing the layouts of a plurality of circuit blocks.

Designing the layouts of the plurality of circuit blocks includes designing layouts of electric components constituting at least one of the circuit blocks, thus, the standard cells are obtained by designing the layouts of the electric components.

Between designing the layout of the circuit blocks and forming the masks, the designed layout may be simulated using a program, such as, a SPICE (simulation program with integrated circuit emphasis). The simulation may verify accuracy of the layout through output results of a circuit block simulated by the layout. Verified results may be stored and provided on the layout data medium 140 as layout data.

The design tool 150 includes a control module 151, a simulation module 152, a determination module 153, a comparison module 154 and a correction module 155.

The control module 151 determines or identifies a target circuit block. The target circuit block is at least one of the plurality of circuit blocks included in the design information medium 120. The control module 151 determines a detailed configuration of the target circuit block in accordance with the device into which the target circuit block is integrated, a location where the target circuit block is integrated, and electrical characteristics specified by the target circuit block from the design information.

In an embodiment, determining a detailed configuration includes subdividing the target circuit block into a plurality of transistors connected to perform an operation or function of the target circuit.

The control module 151 generates the design information and a control command that selects detailed configurations based on the design information. The control module 151 transmits or transfers the design information and the control command to the cell library 130.

When the control command is transmitted to the cell library 130, the cell library 130 provides a selected alt-standard cell to the simulation module 152. The simulation module 152 lays out the electric components of the selected alt-standard cell. The simulation module 152 connects the currently formed electric components with other layout circuit blocks that were previously formed or laid out.

The determination module 153 identifies or determines electrical characteristics and structural characteristics of the target circuit block that is integrated. For example, the determination module 153 identifies or determines the input/output voltage and current characteristics, the wiring resistance, and leakage current characteristics of the target circuit block designed by the selected alt-standard cell. The determination module 153 measures, identifies, or determines the electrical characteristics of the target circuit block in relation to other previously formed circuit blocks (not shown). The determination module 153 identifies or determines the morphological or structural characteristics of each electric component in the target circuit block, such as an active area, a size of a gate, and a wiring geometry (width/length) of the transistors, a size and a location of a contact, and the like. Both the electrical characteristic values and the structural characteristic values measured or determined in the determination module 153 become layout data of the target circuit block. The layout data is transmitted or updated to the layout data medium 140.

The comparison module 154 compares the layout data measured by the determination module 153 with reference layout data stored in the layout data medium 140.

For example, when the layout data measured or determined by the determination module 153 and the reference layout data stored in the layout data medium 140 are within a margin of error, the target circuit block fabricated is normally integrated according to the selected alt-standard cell. Accordingly, the layout data of the alt-standard cell are transmitted to the layout data medium 140.

When the layout data measured by the determination module 153 and the reference layout data stored in the layout data medium 140 differ by more than the margin of error or tolerance, the correction module 155 operates. For example, the correction module 155 changes the location of the alt-standard cell within a predetermined range or corrects one or more of the electric components including the alt-standard cell, such as the size of the active area, the gate width, the wiring width, or the size of the contacts, within a predetermined range. For example, the width of the output current line may be increased, or the length of the current line may be decreased, when the range of the output current is slightly larger than the margin of error.

The electrical and structural characteristics of the target circuit blocks designed according to the alt-standard cells corrected by the correction module 155 determined or identified by the determination module 153. Thereafter, a layout collection including at least one alt-standard cell (or electric component of the alt-standard cell) corrected by the correction module 155 is stored as a new alt-standard cell and provided to the cell library 130. A corrected layout data of the target circuit block is provided to the layout data medium 140.

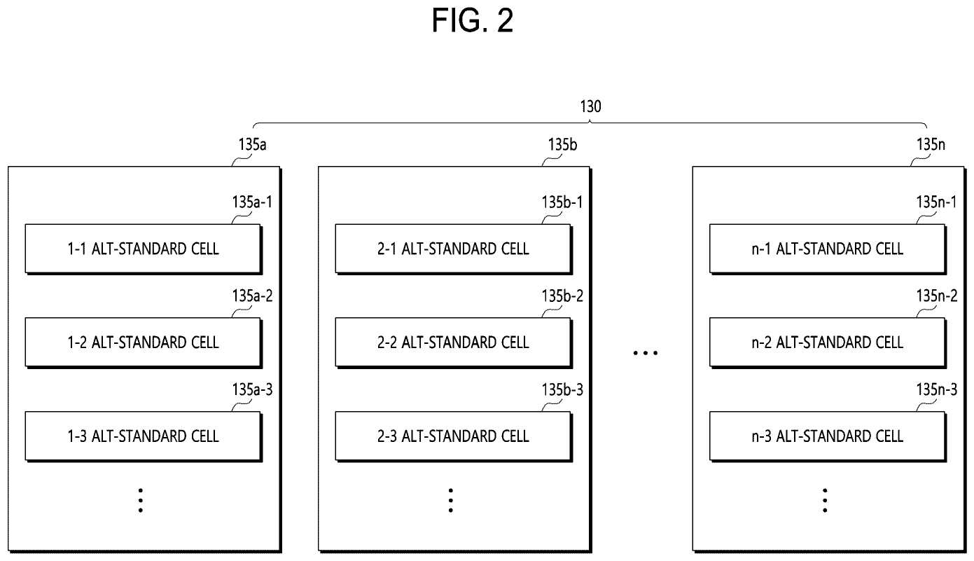

FIG. 2 is a block diagram illustrating a cell library in accordance with an embodiment.

Referring to FIG. 2, the cell library 130 includes n standard cells 135a to 135n, where n is a positive integer.

Each of the standard cells 135a to 135n includes layout patterns for fabricating different circuit blocks. Each of the standard cells 135a to 135n performs different functions.

In an embodiment, the first standard cell 135a includes a layout pattern for at least one latch circuit block. For example, the first standard cell 135a includes a first alt-standard cell 135a-1, a second alt-standard cell 135a-2, and a third alt-standard cell 135a-3 having various structures and performing latching operations.

In an embodiment, a 1-1 alt-standard cell 135a-1 includes a layout pattern for a latch circuit block to be disposed in a pattern dense region. The 1-1 alt-standard cell 135a-1 may be integrated into a cell array region of a highly integrated device with a high integration density such as a memory device. For example, the 1-1 alt-standard cell 135a-1 includes at least one electric component, for example, transistors, wiring, and contacts, having a minimum feature size.

A 1-2 alt-standard cell 135a-2 includes a layout pattern for a latch circuit block to be disposed in a patterned sparse region. Because the 1-2 alt-standard cell 135a-2 may be disposed in an area having a relatively lower integration density than the memory device, the layout patterns in the 1-2 alt-standard cell 135a-2 are disposed with a width and a gap greater than the minimum feature size. For example, the 1-2 alt-standard cell 135a-2 may be applied to a peripheral circuit region of the memory device, a graphics device, or various power devices, or the like. For example, the 1-2 alt-standard cell 135a-2 may be applied to a device that benefits from accurate input/output signals to be obtained regardless of an integration area.

The 1-3 alt-standard cell 135a-3 includes a layout pattern of a latch circuit block applied to a graphics device. Performance of a graphics device is determined by power consumption and heat generation of the graphics device. Therefore, the 1-3 alt-standard cell 135a-3 includes a layout pattern of a latch circuit block in which a length of a resistance, a size of PMOS transistors, and a size of a capacitor are varied such that the power consumption and a heat dissipation are improved. While the first standard cell 135a of an embodiment is illustrated as an example including the 1-1 alt-standard cell 135a-1, 1-2 alt-standard cell 135a-2, and 1-3 alt-standard cell 135a-3, additional layout patterns for latch circuit blocks of various structures and functions may also be included.

In an embodiment, the second standard cell 135b includes a layout pattern for at least one delay circuit block. For example, the second standard cell 135b includes 2-1 alt-standard cell 135b-1, 2-2 alt-standard cell 135b-2, 2-3 alt-standard cell 135b-3, and 2-4 alt-standard cell 135b-4. For example, the alt-standard cells 135b-1 to 135b-4 include different layout patterns for different types of delay circuit blocks according to a device type, a location where the delay circuit block is integrated, and the amount of delay. For example, the 2-1 alt-standard cell 135b-1 includes an inverter chain having a first delay amount. The 2-2 alt-standard cell 135b-2 include a NAND gate chain having a second delay amount. The 2-3 alt-standard cell 135b-3 include a combination of a resistance, an inverter, and a NAND gate having a third delay amount. The 2-4 alt-standard cell 135b-4 includes a metal chain extending in a three-dimensional structure having at least one of the first delay amount, the second delay amount, and the third delay amount. The second standard cell 135b is not limited to these structures and may include a plurality of second alt-standard cells modified to be applicable to various devices and various specifications.

In an embodiment, the nth standard cell 135n includes layout patterns for at least one comparison circuit block. For example, the nth standard cell 135n includes an n-1 alt-standard cell 135n-1, an n-2 alt-standard cell 135n-2, and an n-3 alt-standard cell 135n-3. For example, the alt-standard cells 135n-1 to 135n-3 include layout patterns for different types of the comparison circuit blocks according to a device type, a location where the comparison circuit block is integrated, and a size of an input signal. For example, the n-1 alt-standard cell 135n-1 includes a layout pattern for the comparison circuit block that is applied to a pattern dense region, such as a cell array of a highly integrated memory device. The n-1 alt-standard cell 135n-1 is configured to include a plurality of electric components having a minimum feature size. The n-2 alt-standard cell 135n-2 includes a layout pattern for the comparison circuit block that is applied to the pattern sparse area, such as a peripheral circuit region. The n-2 alt-standard cell 135n-2 is configured to include a plurality of electric components having a size and a width of no less than the minimum feature size. The n-3 alt-standard cell 135n-3 includes a layout pattern for the comparison circuit block that may be included in a graphics device. The n-3 alt-standard cell 135n-3 includes a layout pattern for the comparison circuit block including at least one PMOS transistor that is temperature sensitive, while identifying a resistance path to be as short as possible. The nth standard cell 135n is not limited to these structures, and may include a plurality of alt-standard cells with variations to suit different devices and different specifications.

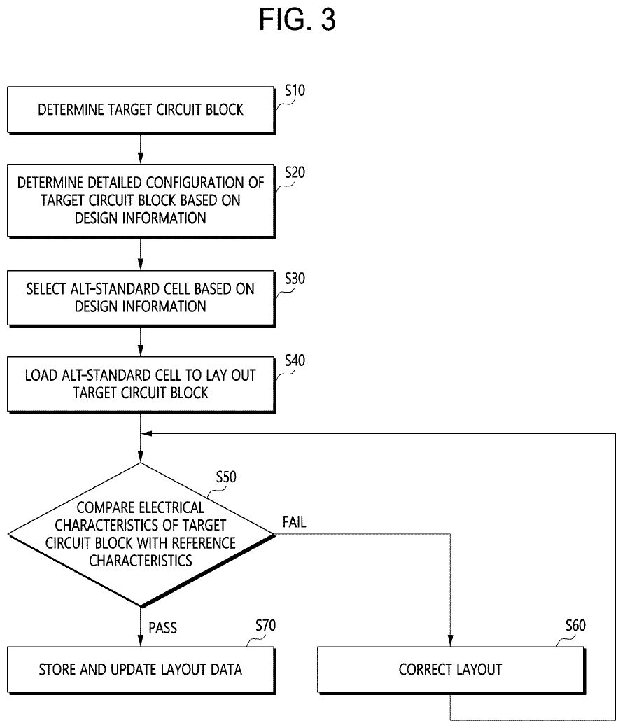

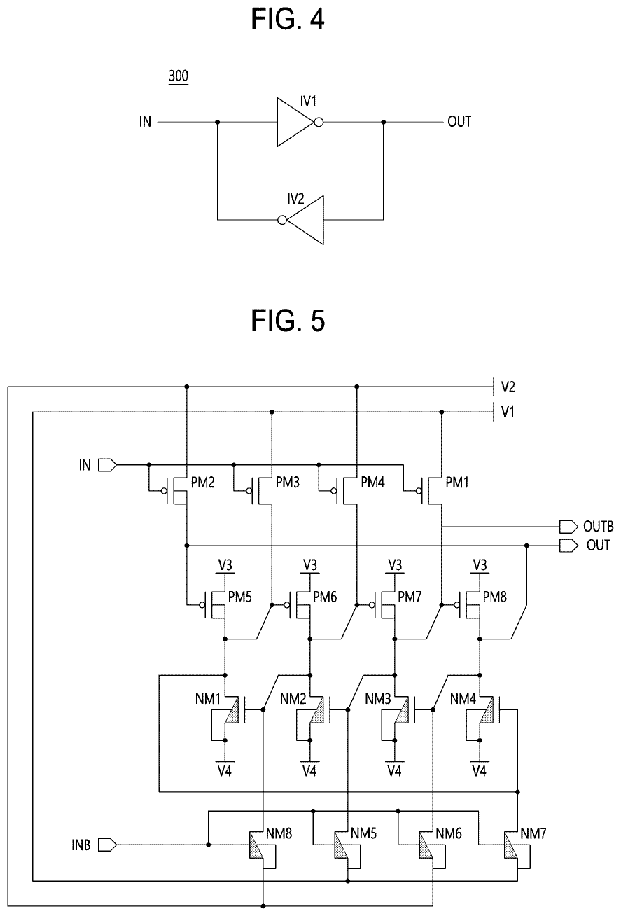

FIG. 3 is a flowchart illustrating a method of designing a semiconductor device utilizing a semiconductor design system in accordance with an embodiment. FIG. 4 is a schematic illustrating one example of a target circuit block in accordance with an embodiment. Referring to FIG. 1 to FIG. 4, the design tool 150 of the semiconductor design system 100 determines or identifies a target circuit block and a detailed configuration of the target circuit block to be simulated S10. The design tool 150 may identify the target circuit block from an input circuit diagram, from a design document or specification, from user input, and so forth stored in the design information medium 120.

The design tool 150 receives various design information related to fabrication of the semiconductor device from the design information medium 120. Based on the various design information, the control module 151 of the design tool 150 categorizes a plurality of circuit blocks utilized during fabrication of the semiconductor device. The control module 151 of the design tool 150 determines or identifies the target circuit block among the plurality of circuit blocks to be integrated.

In an embodiment, the target circuit block is a latch circuit block 300 including a first inverter IV1 and a second inverter IV2 shown in FIG. 4.

For example, the control module 151 of the design tool 150 determines a detailed configuration of the latch circuit block 300 corresponding to the design information based on operating information or specifications of the latch circuit block 300, for example, information including power supply voltage, input voltages IN and INB, and output voltages OUT and OUTB S20.

FIG. 5 is a circuit diagram illustrating an example of a detailed configuration of a latch circuit block that satisfies or meets design conditions or specifications in accordance with an embodiment.

Referring to FIG. 5, the latch circuit block 300 includes eight alt-PMOS transistors PM1 to PM8 interconnected with eight alt-NMOS transistors NM1 to NM8 to perform operations or functions of the first inverter IV1 and the second inverter IV2 in FIG. 4.

The first alt-PMOS transistor PM1 includes a gate configured to receive the input signal IN, a source connected to a first voltage terminal V1, and a drain connected to a gate of the eighth alt-PMOS transistor PM8.

The second alt-PMOS transistor PM2 includes a gate configured to receive the input signal IN, a source connected to a second voltage terminal V2, and a drain connected to a gate of the fifth alt-PMOS transistor PM5. For example, a voltage at the second voltage terminal V2 is an inverted voltage of a voltage at the first voltage terminal V1.

The third alt-PMOS transistor PM3 includes a gate configured to receive the input signal IN, a source connected to the first voltage terminal V1, and a drain connected to a gate of the sixth alt-PMOS transistor PM6.

The fourth alt-PMOS transistor PM4 includes a gate configured to receive the input signal IN, a source connected to the second voltage terminal V2, and a drain connected to a gate of the seventh alt-PMOS transistor PM7.

The fifth alt-PMOS transistor PM5 includes a gate configured to receive the output signal OUT and connected to the drain of the second alt-PMOS transistor PM2, a source connected to a third voltage terminal V3, and a drain connected to a drain of the first alt-NMOS transistor NM1. The third voltage terminal V3 continuously receives a power supply voltage at a logic high.

The sixth alt-PMOS transistor PM6 includes a gate commonly connected to the drain of the fifth alt-PMOS transistor PM5 and the drain of the third alt-PMOS transistor PM3, a source connected to the third voltage terminal V3, and a drain connected to the drain of the second alt-NMOS transistor NM2.

The seventh alt-PMOS transistor PM7 includes a gate commonly connected to the drain of the sixth alt-PMOS transistor PM6 and the drain of the fourth alt-PMOS transistor PM4, a source connected to the third voltage terminal V3, and a drain connected to the drain of the third alt-NMOS transistor NM3.

The eighth alt-PMOS transistor PM8 includes a gate commonly connected to the drain of the seventh alt-PMOS transistor PM7 and the drain of the first alt-PMOS transistor PM1, a source connected with the third voltage terminal V3, and a drain connected with the drain of the fourth alt-NMOS transistor NM4.

The first alt-NMOS transistor NM1 includes a gate connected to the drain of the sixth alt-PMOS transistor PM6, a source connected to a fourth voltage terminal V4, and a drain connected to the drain of the fifth alt-PMOS transistor PM5. The fourth voltage terminal V4 is a ground power source at a logic low.

The second alt-NMOS transistor NM2 includes a gate connected to the drain of the seventh alt-PMOS transistor PM7, a source connected to the fourth voltage terminal V4, and a drain connected to the drain of the sixth alt-PMOS transistor PM6.

The third alt-NMOS transistor NM3 includes a gate connected to the drain of the eighth alt-PMOS transistor PM8, a source connected to the fourth voltage terminal V4, and a drain connected to the drain of the seventh alt-PMOS transistor PM7.

The fourth alt-NMOS transistor NM4 includes a gate connected to the drain of the first alt-NMOS transistor NM1, a source connected to the fourth voltage terminal V4, and a drain connected to the drain of the eighth alt-PMOS transistor PM8.

The fifth alt-NMOS transistor NM5 includes a gate configured to receive the inverted input signal INB, a source connected to the first voltage terminal V1, and a drain connected to the drain of the third alt-NMOS transistor NM3.

The sixth alt-NMOS transistor NM6 includes a gate configured to receive the inverted input signal INB, a source connected to the second voltage terminal V2, and a drain connected to the drain of the fourth alt-NMOS transistor NM4.

The seventh alt-NMOS transistor NM7 includes a gate configured to receive the inverted input signal INB, a source connected to the first voltage terminal V1, and a drain connected to the gate of the fourth alt-NMOS transistor NM4.

The eighth alt-NMOS transistor NM8 includes a gate configured to receive the inverted input signal INB, a source connected to the second voltage terminal V2, and a drain connected to the drain of the second alt-NMOS transistor NM2.

A first output signal line OUT1 connects a connection node of the eighth alt-PMOS transistor PM8 and the fourth alt-NMOS transistor NM4. A second output signal line OUT2 connects a connection node of the first alt-PMOS transistor PM1 and the third alt-NMOS transistor NM3. For example, the second output signal line OUT2 is at an inverted voltage level OUTB of the first output signal line OUT1 that is at voltage level OUT.

As shown in FIG. 5, when the detailed configuration of the target circuit block is identified, a alt-standard cell that is closest in characteristics to the detailed design information for the target circuit block, including a device type, the input and output characteristics of the target circuit block, and the integration location of the target circuit block, is selected from the detailed design information S30.

For example, the control module 151 utilizes the detailed configuration of the latch circuit block 300 together with the detailed design information to determine the integrated area and geometry of the latch circuit block 300. In order to select the alt-standard cell that best matches the determined latch circuit block 300 integrated area and shape, the control module 151 generates a control command that selects the alt-standard cell and transmits or transfers the control command to the cell library 130.

In response to receiving the command, the cell library 130 selects a first standard cell 135a from the plurality of standard cells 135a to 135n that matches the latch circuit function. The cell library 130 selects an alt-standard cell, from the first standard cell 135a, that matches detailed design information, for example, a device type, an integration location, electrical characteristics, and so forth, for the target circuit block.

The selected alt-standard cell is loaded into the simulation module 152 of the design tool 150. The selected alt-standard cells is laid out in the simulation module S40. The simulation module 152 may place and route layout patterns of the selected alt-standard cell on previously formed layout patterns.

The determination module 153 determines or identifies the electrical characteristics of the target circuit block laid out at S40. The comparison module 154 compares the electrical characteristics of the target circuit block with the reference electrical characteristics S50.

When the electrical characteristics of the target circuit block differ from the reference electrical characteristics of the selected alt-standard cell by more than a margin of error or tolerance (fail), the correction module 155 corrects a structure of the layout pattern of the target circuit block, such as changing the size and the width of the electric components including the alt-standard cell S60. The characteristics of the corrected alt-standard cell are determined or identified by the determination module 153 and compared by the comparison module 154.

When the electrical characteristics and structural characteristics of the target circuit block according to the alt-standard cell, or the target circuit block according to the corrected alt-standard cell, are within the margin of error or tolerance (pass), the layout data of the alt-standard cell is transmitted to the layout data medium 140 to be stored and updated S70.

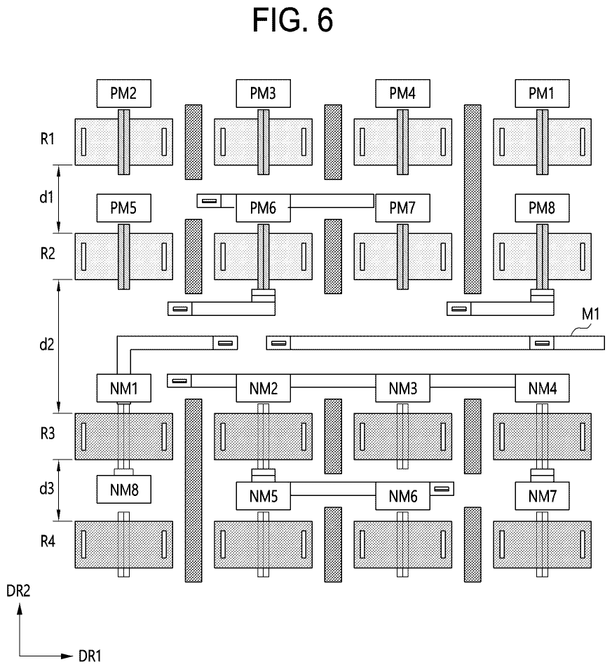

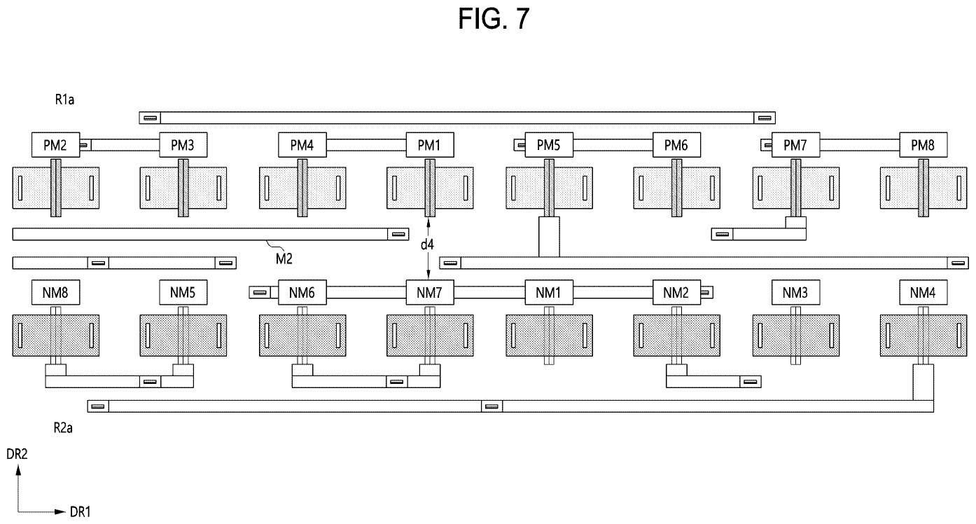

FIG. 6 illustrates a layout of a 1-1 alt-standard cell, for example, as shown in FIG. 5, and FIG. 7 illustrates a layout of a 1-2 alt-standard cell, for example, as shown in FIG. 5.

In an embodiment, when a latch circuit block 300 having the configuration of FIG. 5 is placed in a highly integrated device or a pattern dense region, the cell library 130 selects a 1-1 alt-standard cell 135a-1 in which 16 transistors including the latch circuit block 300 are arranged side-by-side in four rows.

For example, the 1-1 alt-standard cell 135a-1 includes the alt-PMOS transistors PM1 to PM4 arranged along a first direction DR1 at a first interval or spacing to form a first row R1, as shown in FIG. 6.

The alt-PMOS transistors PM5 to PM8 are arranged along the first direction DR1 at the first interval or spacing. The alt-PMOS transistors PM5 to PM8 are arranged to form a second row R2 parallel to the first row R1. The first row R1 spaced apart from the second row R2 by a first distance d1.

The alt-NMOS transistors NM1 to NM4 are arranged along the first direction DR1 at a second interval or spacing. The alt-NMOS transistors NM1 to NM4 are arranged to form a third row R3 parallel to the second row R2. The second row R2 spaced apart from the third row R3 by a second distance d2. For example, the second distance d2 is greater or larger than the first distance d1 to accommodate an arrangement of wiring interconnections that connect the alt-PMOS transistors and the alt-NMOS transistors.

The NMOS transistors NM5 to NM8 are arranged along the first direction DR1 at the second interval or spacing. The NMOS transistors NM5 to NM8 are arranged to form a fourth row R4 parallel to the third row R3. The third row R3 is spaced apart from the fourth row R4 by a third distance d3. The third distance d3 may be the same as or different from the first distance d1. For example, the third distance d3 may be smaller than the second distance d2 and the first distance d1.

When the latch circuit block 300 is disposed in a patterned sparse region with relatively low integration density, the cell library 130 selects the 1-2 alt-standard cell 135a-2 such that the 16 transistors including the latch circuit block 300 are arranged side by side in two rows.

For example, as shown in FIG. 7, the 1-2 alt-standard cell 135a-2 includes a first row R1a spaced apart from a second row R2a by a fourth distance d4.

The first row R1a includes PMOS transistors PM1 to PM8 arranged side by side along the first direction DR1. The PMOS transistors PM1 to PM8 may be spaced apart from each other by various intervals according to a pitch of the wiring and efficiency of the wiring connections. The PMOS transistors PM1 to PM8 may be arranged in a non-sequential order to facilitate efficiency of the wiring connections.

The second row R2a includes NMOS transistors NM1 to NM8 arranged side by side along the first direction DR1. The NMOS transistors NM1 to NM8 may be spaced apart from each other by various intervals according to the pitch of the wiring and efficiency of the wiring connections. The NMOS transistors NM1 to NM8 may be arranged in a non-sequential order to facilitate efficiency of the wiring connections.

In an embodiment, sizes of the PMOS transistors PM1 to PM8 of the 1-2 alt-standard cell 135a-2, for example, sizes of active areas of the PMOS transistors PM1 to PM8 and the widths of the gates, may be larger than sizes of the PMOS transistors PM1 to PM8 of the 1-1 alt-standard cell 135a-1. For example, sizes of active areas of the PMOS transistors PM1 to PM8 and widths of the gates of the 1-2 alt-standard cell 135a-2 are larger than the size of the PMOS transistors PM1 to PM8 of the 1-1 alt-standard cell 135a-1.

Sizes of the NMOS transistors NM1 to NM8 of the 1-2 alt-standard cell 135a-2, for example, a size of active areas of the NMOS transistors NM1 to NM8 and widths of the gates, may be larger than sizes of the NMOS transistors NM1 to NM8 of the 1-1 alt-standard cell 135a-1. For example, sizes of active areas of the NMOS transistors NM1 to NM8 and widths of the gates of the 1-2 alt-standard cell 135a-2 are larger than the sizes of the NMOS transistors NM1 to NM8 of the 1-1 alt-standard cell 135a-1.

A width of each of the wires M2 interconnecting the transistors PM1 to PM8 and NM1 to NM8 in the 1-2 alt-standard cell 135a-2 may be larger than a width of each of the wires M1 interconnecting the transistors PM1 to PM8 and NM1 to NM8 in the 1-1 alt-standard cell 135a-1.

According to an embodiment, the standard cell, including a set of layouts separated by circuit block function, for example, based on the first design information, are subdivided into alt-standard cells based on the second design information, for example, a device type and an integration location, in addition to the functions, and the different alt-standard cells are organized in the cell library.

As a result, when designing semiconductor devices, shortened design time for the target circuit block as well as integration density improvement for the device may result by loading and utilizing the appropriate alt-standard cells based on specifications for the target circuit block and the alt-standard cell.

Concepts are disclosed in conjunction with examples and embodiments as described above. Those skilled in the art will understand that various modifications, additions, and substitutions are possible without departing from the scope and technical concepts of the present disclosure. The embodiments disclosed in the present specification should be considered from an illustrative standpoint and not a restrictive standpoint. Therefore, the scope of the present disclosure is not limited to the above descriptions. All changes within the meaning and range of equivalency of the claims are included within their scope.

What is claimed is:

1. A semiconductor design system comprising:
a design information medium configured to provide first design information and second design information, the first design information including information about a plurality of circuit blocks configured to be integrated into a semiconductor device and at least one function of the plurality of circuit blocks, and the second design information including an integration location of the plurality of circuit blocks and an input/output characteristic of the plurality of circuit blocks;
a cell library configured to a store layout pattern of each of the plurality of circuit blocks as a different one of a plurality of standard cells; and
a design tool operably coupled to the design information medium and the cell library, configured to select a standard cell, among the plurality of standard cells, including a layout pattern of a target circuit block based on the first design information and the second design information, and configured to load the layout pattern of the selected standard cell;
wherein each of the plurality of standard cells of the cell library is categorized based on the first design information; and
wherein each of the standard cells includes a plurality of alt-standard cells, each of the plurality of alt-standard cells having a different layout pattern based on the second design information.

2. The semiconductor design system of claim 1, further comprising a layout data medium operably coupled to the design tool and configured to determine electrical characteristics of the target circuit block that is laid out and configured to store the determination results as layout data.

3. The semiconductor design system of claim 1, wherein the design tool comprises:
a control module configured to determine the target circuit block based on the first design information and configured to generate a control command that selects the alt-standard cell based on the second design information;
a simulation module configured to lay out the target circuit block in a form of the selected alt-standard cell in response to the control command;
a determination module configured to determine electrical characteristics of the target circuit block that is laid out; and
a correction module configured to correct at least one of a size and an integration location of the alt-standard cells based on the determination results of the determination module.

4. The semiconductor design system of claim 3, further comprising a layout data medium configured to determine the electrical characteristics of the target circuit block that is laid out and configured to store results of the determination as layout data,
wherein the design tool further comprises a comparison module configured to compare the electrical characteristics and structural characteristic of the target circuit block with reference layout data.

5. The semiconductor design system of claim 4, wherein the layout data medium is configured to receive a corrected size of an electric component in the target circuit block corrected by the correction module and a corrected electrical characteristic of the target circuit block.

6. The semiconductor design system of claim 1, wherein the standard cell comprises a circuit block configured to perform a first function of the at least one function,
wherein the standard cell comprises:
a first alt-standard cell designed with an interval of a minimum feature size;
a second alt-standard cell including electric components in the circuit block arranged to extend longer in a first direction; and
a third alt-standard cell including electric components in the circuit block arranged to extend longer in the second direction than in the first direction, where the second direction is different from the first direction.

7. The semiconductor design system of claim 6, wherein the second alt-standard cells and the third alt-standard cells comprise the same quantity of transistors.

8. A method of designing a semiconductor device, the method comprising:
determining, by a design tool, a target circuit block to designed;
identifying, by the design tool, a function of the target block;
selecting, by the design tool, a standard cell configured to perform the function of the target circuit block;
determining, by the design tool, a detailed configuration of the target circuit block according to a power characteristic and an input/output characteristic of the target circuit block;
based on circuit block information including the detailed configuration of the target circuit block, a device type to which the target circuit block is applied, and an integration location for the target circuit block, selecting, by the design tool, an alt-standard cell among a plurality of alt-standard cells associated with the selected standard cell, for which the alt-standard cell has circuit block information that most closely matches the circuit block information for the target circuit block; and
laying out, by the design tool, the target circuit block by loading the selected alt-standard cell.

9. The method of claim 8, further comprising determining electrical characteristics of the laid out target circuit block.

10. The method of claim 8, wherein a size of electric components in the selected alt-standard cell is corrected when a difference between electrical characteristics of the laid out target circuit block and reference electrical characteristics of the target circuit block is beyond a margin of error.

11. The method of claim 10, wherein the electric components comprise a plurality of transistors, a plurality of wirings configured to connect the transistors, and a plurality of contacts configured to connect the transistors with the wirings, and
wherein correcting sizes of the electric components comprises changing at least one of an active area of the transistor, a gate width of the transistor, the width and length of the wiring, and a size of a contact configured to electrically connect the wirings to each other.

12. A semiconductor design system comprising:
a processor; and
memory including stored instructions that, when executed by the processor, perform functions of a design tool including:
generating design information and a control command that selects detailed configurations based on the design information for a target circuit block that performs a function;
in response to receiving the command, selecting a standard cell, from a plurality of standard cells, that performs the function;
selecting an alt-standard cell included in the standard cell, which alt-standard cell has detailed design information that most closely matches design information for the target circuit block; and
laying out the target circuit block by loading the selected alt-standard cell.
